(19) United States
(12) Patent Application Publication
(10) Pub. No.: US 2014/0163123 A1
(43) Pub. Date: Jun. 12, 2014

(54) HYDROPHILIC THERMAL RETICULATED POLYURETHANE FOAM USEABLE FOR CREATION OF A MOLTEN METAL FILTER

(71) Applicant: INOAC USA, Inc., Troy, MI (US)

(72) Inventor: Fuminori Horio, Cresskill, NJ (US)

(73) Assignee: INOAC USA, Inc., Troy, MI (US)

(21) Appl. No.: 14/098,690

(22) Filed: Dec. 6, 2013

Related U.S. Application Data
(60) Provisional application No. 61/734,546, filed on Dec. 7, 2012.

(51) Int. Cl. C08L 75/06

(52) U.S. Cl. CPC C08L 75/06
USPC 521/52

(57) ABSTRACT

A hydrophilic, polyurethane foam manufactured from a composition that includes 90-110 parts by weight of polyester polyol, 0.9-1.1 parts by weight of ester surfactant, 3-20 parts by weight of a hydrophilic surfactant, 1.89-2.31 parts by weight of a polyurethane catalyst, 0.126-0.154 parts by weight of an amine catalyst, 3.348-4.092 parts by weight of water, and 46.98-57.42 parts by weight of toluene diisocyanate. The polyurethane is capable of absorbing water in a time period of about 5 minutes or less. The polyurethane foam is a precursor to the formation of a molten metal filter.

### CROSS-REFERENCE TO RELATED APPLICATION(S)

This is a United States Non-Provisional Patent Application that relies for priority on U.S. Provisional Patent Application Ser. No. 61/734,546, filed on Dec. 7, 2012, the entire contents of which are incorporated herein by reference.

### FIELD OF THE INVENTION

The present invention concerns a thermal reticulated polyurethane foam useable for creation of a molten metal filter. The foam of the present invention includes a fully opened cell structure that results from a thermal reticulation process. The foam is capable of absorbing water in less than about five (5) minutes.

### DESCRIPTION OF RELATED ART

Thermal reticulated polyurethane foam has been used to create filter materials for molten metals because a reticulated foam incorporates an open cell structure. As should be apparent, for a molten metal filter to perform in a suitable manner, the structure should present a fully opened, interconnected void structure so that the molten metal may flow through the open structure.

As should be apparent to those skilled in the art, one way to create a molten metal filter is to impregnate a ceramic slurry into a reticulated polyurethane foam. Specifically, after the ceramic slurry impregnates the voids in the reticulated foam structure, the ceramic is heated (or fired) so that the ceramic forms a rigid structure. During the heating or firing process, the polyurethane is burned out of the ceramic slurry, thereby leaving only the hardened (or fired) ceramic structure.

One problem with reticulated polyurethane foam is that it is hydrophobic. This means that water, with a wetting angle of greater than 90 degrees, does not tend to spread out over the surface of polyurethane.

As should be apparent to those skilled in the art, the hydrophobic nature of reticulated polyurethane foam impedes the formation of a molten metal filter, because ceramic slurries used to manufacture the filter typically are water based. As such, ceramic slurries do not effectively wet the surface of hydrophobic polyurethane foam. This may lead to poor spreading of slurry over the surface of polyurethane and poor resultant strut formation when the filter is formed during heating or firing.

To compensate for poor spreading of the slurry over the surface of the foam it is common to apply the ceramic slurry under pressure. Given the hydrophobic properties of reticulated polyurethane foam, it is common to apply high pressure to force the ceramic slurry through the pores of foam.

Alternatively, it is possible to create a hydrophilic polyurethane foam. For example, hydrophilic polyurethane foams may be prepared by “prepolymer” process in which a hydrophilic prepolymer isocyanate end group is mixed and reacted with water. Hydrophilic polyurethane foams are described by U.S. Pat. Nos. 3,861,993 and 3,889,417.

Creating hydrophilic polyurethane foams using a prepolymer has at least one known drawback. Specifically, the process often results in the creation of a foam structure that is not fully opened. Often, the foam includes thin membranes between individual voids, thereby diminishing the ability of the foam to form a metal filter after being wetted with a ceramic slurry.

Hydrophilic foams have been used to create molten metal filters. For example, U.S. Pat. No. 3,833,386 (hereinafter “the '386 patent”) discloses a foam made by a hydrophilic prepolymer technique that may be used to create a molten metal filter. It is noted, however, that the foam described in the '386 patent is nothing more than a foam with a conventional, open-celled structure, unlike a reticulated foam with a fully opened cell structure. Moreover, the foam described in the '386 patent has a much higher density than typical, reticulated foams. As a result, it is difficult (if not impossible) to control pore size to establish sufficient void space for the creation of a molten metal filter material.

U.S. Patent Application Publication No. 2006/0284351 describes a technique whereby “quenching” of the reticulated foam results in a material suitable for creation of a molten metal filter. “Quenched” reticulated foam is more hydrophilic than conventional, thermally reticulated foam. However, the “quenching” process is more expensive than the thermal reticulation process and the foam produced by a quenching process performs poorly by comparison with a thermally reticulated foam.

European Patent No. 0 412 673 describes a technique where a polyurethane foam is impregnated with an aqueous slurry of ceramic material containing a binder. The impregnated foam is dried to remove water and the dried, impregnated foam is fired to burn off the organic foam, leaving behind the ceramic filter.

European Patent No. 0 649 334 describes a similar process whereby an organic foam, such as a polyurethane foam, is used to manufacture a ceramic filter for molten metals, especially light metals.

U.S. Pat. No. 7,963,402 also describes the formation of a molten metal filter from an organic plastic foam that has been impregnated with a ceramic slurry and fibers with a length of 0.1-5.0 mm.

U.S. Pat. Nos. 2,360,929, 2,752,258, 3,947,363, 5,456,833, and 5,045,511 provide additional commentary with respect to the manufacture of ceramic filters used for molten metal, where the filters are manufactured using an organic foam precursor.

U.S. Pat. No. 6,203,593 describes the use of a reticulated polyurethane foam to create a ceramic filter for filtering molten metals.

U.S. Pat. No. 4,866,011 describes the formation of ceramic filters using hydrophobic flexible foam materials that includes an adhesive to increase foam flexibility and impregnation.

U.S. Pat. Nos. 4,342,664, 4,056,586, and 4,265,659 describe the formation of ceramic filters using a hydrophilic polyurethane foam with a structure defining 5 to 100 ppi.

U.S. Pat. Nos. 4,024,212 and 4,075,303 describes the formation of a ceramic filter using a polyester polyurethane foam precursor.

In view of the foregoing, there remains room for improving the formation of molten metal filters using thermally reticulated, hydrophilic, polyurethane foams.

### SUMMARY OF THE INVENTION

The present invention addresses one or more of the deficiencies associated with respect to the prior art.

In one contemplated embodiment, the present invention provides for a hydrophilic, polyurethane foam, formed from 90-110 parts by weight of polyester polyol, 0.9-1.1 parts by weight of ester surfactant, 3-20 parts by weight of a hydrophilic surfactant, 1.89-2.31 parts by weight of a polyurethane catalyst, 0.126-0.154 parts by weight of an amine catalyst, 3.348-4.092 parts by weight of water, and 46.98-57.42 parts by weight of toluene diisocyanate. The polyurethane is capable of absorbing water in a time period of about 5 minutes or less. The foam is a precursor to the formation of a molten metal filter.

In other contemplated embodiments, the foam may include 3-15 parts by weight, 3-10 parts by weight, 4-9 parts by weight, 5-8 parts by weight, or 6-7 parts by weight of a hydrophilic surfactant.

The foam may be reticulated. If so, the foam may be thermally reticulated.

In one contemplated embodiment, it is contemplated that the toluene diisocyanate in the foam may include at least two isomeric forms comprising 2,4-toluene diiscynate and 2,6-toluene diisocyanate.

In another contemplated embodiment, the foam may include 95-105 parts by weight of polyester polyol, 0.95-1.05 parts by weight of ester surfactant, 2.00-2.21 parts by weight of a polyurethane catalyst, 0.133-0.147 parts by weight of an amine catalyst, 3.534-3.906 parts by weight of water, and 49.60-54.82 parts by weight of toluene diisocyanate.

Still further, it is contemplated that the foam may include 98-102 parts by weight of polyester polyol, 0.98-1.02 parts by weight of ester surfactant, 2.06-2.14 parts by weight of a polyurethane catalyst, 0.137-0.143 parts by weight of an amine catalyst, 3.646-3.794 parts by weight of water, and 51.16-53.24 parts by weight of toluene diisocyanate.

In another contemplated embodiment, the foam may include 99-101 parts by weight of polyester polyol, 0.99-1.01 parts by weight of ester surfactant, 2.08-2.12 parts by weight of a polyurethane catalyst, 0.139-0.141 parts by weight of an amine catalyst, 3.683-3.757 parts by weight of water, and 51.68-52.72 parts by weight of toluene diisocyanate.

Additionally, it is contemplated that the hydrophilic surfactant may be polyether modified polysiloxane.

In one contemplated embodiment, the hydrophilic surfactant may include poly(oxy-1,2-ethanediyl), a-methyl-w-[3-[1,3,3,3-tetramethyl-1-[(trimethylsilyl)oxy]disiloxanyl]propoxy], and disiloxane, hexamethyl.

The foam may form a web having pores with a density of about 2-100 ppi, 2-70 ppi, 5-35 ppi, and/or 10-30 ppi.

It is contemplated that the time period for absorption of water may be less than about four (4) minutes, less than about three (3) minutes, less than about two (2) minutes, and/or less than about one (1) minute.

In addition, it is contemplated that the foam may have a density of between about 1.2 and 3 lb/ft³ (0.019-0.048 g/cm³). Alternatively, the foam may have a density of between about 1.4 and 1.9 lb/ft³ (0.022-0.030 g/cm³). Still further, the foam may have a density of about 1.8 lb/ft3 (“pcf”) (0.0288 g/cm³).

Further advantages of the present invention will be made apparent from the discussion provided below.

### BRIEF DESCRIPTION OF THE DRAWING(S)

The present patent invention is described without reliance on any appended drawings.

### DETAILED DESCRIPTION OF EMBODIMENT(S) OF THE INVENTION

The present invention is directed to a hydrophilic, thermally reticulated, polyurethane foam that presents a suitable pore size for the formation of a molten metal filter after being wetted with a ceramic slurry. The polyurethane foam forms a web or structure that is wetted with a slurry, such as a ceramic slurry, to form a ceramic filter suitable for filtering molten metal.

In one particular embodiment, the polyurethane foam of the present invention presents a density and a pore size whereby the foam may be wetted (or can absorb water) in less than about five (5) minutes. In another contemplated embodiment, the present invention provides a polyurethane foam that wets in less than about four (4) minutes. In still another embodiment, the present invention encompasses a polyurethane foam that absorbs water in less than about three (3) minutes. A further contemplated embodiment includes a polyurethane foam that wets in less than about two (2) minutes. The present invention also contemplates an embodiment where the polyurethane foam absorbs water in less than about a minute (one (1) minute). Most specifically, the polyurethane foam of the present invention wets in about 38 seconds.

The wettability of the polyurethane foam of the present invention facilitates the manufacture of a molten metal filter. First, being wettable, the polyurethane foam freely draws (or receives) a water-based ceramic slurry into the pores of its reticulated structure. Second, because the polyurethane foam may be wetted with the ceramic slurry in a relatively short period of time, the duration of the manufacturing process may be managed within a suitably brief time interval, thereby improving the commercial appeal of the manufacturing process, among other benefits.

In one contemplated embodiment, the hydrophilic, polyurethane foam of the present invention is manufactured via a thermal reticulation process. However, a thermal reticulation process is not required to practice the present invention. The foam may be reticulated via other methods and processes as should be apparent to those skilled in the art.

In one embodiment, it is contemplated that the foam is made using a surfactant (e.g., a hydrophilic surfactant) with a concentration of about 3-20 parts by weight (or “pbw”). In one contemplated variant, the present invention is made using a surfactant with a concentration of about 3-15 parts by weight. Still further, the foam of the present invention may be made using a surfactant with a concentration of about about 3-10 parts by weight. More specifically, the foam may be made using surfactant with a concentration of about 4-9 parts by weight. Still further, the foam of the present invention may be manufactured using surfactant with a concentration of about 5-8 parts by weight. Finally, it is contemplated that the foam of the present invention may be made using surfactant with a concentration of about 6-7 parts by weight, about 6 parts by weight, or about 7 parts by weight, among other variations. The surfactant in these examples may be a compound such as polyether modified polysiloxane. Other additives, including different types of surfactants, may be employed in the alternative, as should be apparent to those skilled in the art.

The term “surfactant” is used broadly with respect to the present invention. It is intended to have a broad scope, as would be understood by those skilled in the art. To assist with an understanding of the scope of the present invention, a surfactant is defined as a compound (or group of compounds) that lower the surface tension of a liquid, the interfacial tension between two liquids, or the surface tension between a liquid and a solid. Surfactants may act as detergents, wetting agents, emulsifiers, foaming agents, and dispersants. Surfactants are usually organic compounds that are amphiphilic, meaning they contain both hydrophobic groups (their tails) and hydrophilic groups (their heads). Therefore, a surfactant contains both a water insoluble (or oil soluble) component and a water soluble component. Surfactants will diffuse in water and adsorb at interfaces between air and water or at the interface between oil and water, in the case where water is mixed with oil. The insoluble hydrophobic group may extend out of the bulk water phase, into the air or into the oil phase, while the water soluble head group remains in the water phase. This alignment of surfactants at the surface modifies the surface properties of water at the water/air or water/oil interface.

With regard to the use of a surfactant, it is noted that conventional foams typically employ 0.5-1.5 parts by weight of surfactant or less. As should be apparent, therefore, with a surfactant concentration of 3-20 parts by weight, the polyurethane foam of the present invention employs two (2) to more than forty (40) times more surfactant than conventional foams.

With respect to pore size, the foam of the present invention has a pore size of about 2-100 ppi (pores per inch). In another contemplated embodiment, the pore size of the foam of the present invention is less than about 70 ppi. In one embodiment, the pore size is between about 2 to 70 ppi. In another embodiment, the pore size is between about 2 and 50 ppi. In still another embodiment, the pore size is about 5-35 ppi. Still further, the pore size may be between about 10-30 ppi. A preferred pore size is about 25 ppi in one contemplated embodiment.

For the foam of the present invention, it is contemplated that the foam has a density between about 1.2 and 3 pounds per cubic foot (lb/ft³) (0.019-0.048 g/cm³). In one specific embodiment, the foam is contemplated to have a density of between about 1.4 and 1.9 lb/ft³ (0.022-0.030 g/cm³). Still further, the foam may have a density of about 1.8 lb/ft³ (0.0288 g/cm³). This is considerably less than prior art foams, which typically have a density of 6 lb/ft³ (0.096 g/cm³) or more.

In this regard, a density for the foams of the present invention represents a measurable departure from the prior art. Specifically, in the prior art, it is not possible to create foams with a low density, such as those of the present invention, using a prepolymer technique. As noted, foams made using a prepolymer technique have a density of 6 lb/ft³ (0.096 g/cm³) or more, which is considerably higher than the density of the foam of the present invention. Specifically, prior art foams have a density that is two or more times greater than the foam of the present invention.

As noted above, the foam of the present invention is contemplated to be made using a surfactant known as HPH2 (also referred to herein as a hydrophilic surfactant).

HPH2 is a polyether-modified polysiloxane sold under the trade name Ortegol HPH 2 (referred to herein as “HPH2”) by the Evonik Goldschmidt Corporation with a business address at 914 East Randolph Road, Hopewell, Va. 23860, United States of America.

According to the material specification for the compound dated Oct. 12, 2011 (incorporated herein in its entirety by reference), HPH2 includes two primary components: (1) poly(oxy-1,2-ethanediyl), a-methyl-w-[3-[1,3,3 ,3-tetramethyl-1-[(trimethylsilyl)oxy]disiloxanyl]propoxy] in a concentration of >75% and (2) disiloxane, hexamethyl with a concentration of <0.1%. HPH2 has a flash point that is greater than 200° F. (93.33° C.) as measured by the TAG CC method. HPH2 is a Class IIIB combustible liquid with a yellow to brownish color. HPH2 is water soluble. HPH2 has a pH of 4.5-6.8 at 40 g/l water and at 20° C. HPH2 has a reported weight per volume of 8.41 lb/gal (1.00774 g/cc) and a dynamic viscosity of 11-24 mPA·s at 25° C.

While not intended to be limiting of the present invention, three contemplated examples of the composition of the foam of the present invention are provided by the table below, listed as “Example 1,” “Example 2,” and “Example 3.” A comparison with a prior art foam also is provided.

TABLE #1

| | Example 1 | Example 2 | Example 3 | Comparison 1 |
|---|---|---|---|---|
| 2C-76 | 100 | 100 | 100 | 100 |
| B8330 | 1.0 | 1.0 | 1.0 | 1.0 |
| HPH2 | 3.0 | 4.0 | 5.0 | 0 |
| M-75 | 2.1 | 2.1 | 2.1 | 2.1 |
| B-16 | 0.14 | 0.14 | 0.14 | 0.14 |
| Water | 3.72 | 3.72 | 3.72 | 3.72 |
| T-80 | 26.1 | 26.1 | 26.1 | 26.1 |
| T-65 | 26.1 | 26.1 | 26.1 | 26.1 |
| Density (pcf) | 1.8 | 1.8 | 1.8 | 1.8 |
| Pore size (ppi) | 40 | 40 | 40 | 40 |
| Absorption (sec) | 50 | 38 | 30 | >7 hours |

For reference, the abbreviations provided above refer to the following materials: (1) 2C-76: polyester polyol, OHV=60, by Chemtura Corporation, with a business address at 199 Benson Road, Middlebury, Conn. 06749, United States of America, (2) B8330: conventional ester surfactant, by Evonik, (3) HPH2: hydrophilic surfactant by Evonik (as discussed above), (4) M-75: (amine) catalyst by the Huntsman Corporation, with a business address at 10003 Woodloch Forest Drive, The Woodlands, Tex. 77380, United States of America, (5) B-16: (amine) catalyst by Air Products, Inc., with a business address at 7201 Hamilton Blvd., Allentown, Pa. 18195-1501, United States of America, and (6) T-80, T-65: toluene diisocyanate by the Bayer Corporation, with a business address at 100 Bayer Road, Building 4, Pittsburg, Pa. 15205-9741, United States of America. These compounds should not be understood to be limiting of the present invention.

The proportions listed in Table #1 are proportions by weight (i.e., parts) unless specific units are otherwise specified. As is apparent from Table #1, the only variable that differs from the four compositions is the addition of HPH2 in Examples ##1-3. HPH2 decreases the absorption rate of the foam from a period greater than 7 hours to a time period of less than one minute. As noted above, a shorter absorption time speeds up the manufacturing process.

With respect to Examples ##1-3, the following additional information is provided.

C2-76 is a polymer resin sold under the product name Fomrez 2C76 by Chemtura Corporation (referred to herein as “C2-76”). According to the Material Safety Data Sheet for the compound dated Nov. 4, 2013 (incorporated herein in its entirety by reference), with a revision date of Jul. 30, 2012, 2C-76 is a polymer with a flash point of more than 379° F. (193° C.).

B8330 is a mixture of polyether-modified polysiloxane and surfactants sold under the trade name Tegostab B 8330 (referred to herein as “B8330”) by the Evonik Corporation, which is identified above. According to the Material Safety Data Sheet for the substance (dated Dec. 8, 2006, with a revision date of Dec. 7, 2007) (incorporated herein in its entirety by reference), B8330 is a dark brown liquid that includes three ingredients: (1) propanol, oxybis-, with a concentration of 31.5%, (2) siloxanes and silicones, Di-Me, 3-hydroxypropyl Me, ethers with polyethylene glycol mono-Me ether, with a concentration of 19.75%, and (3) distillates, petroleum, hydrotreated light naphthenic, with a concentration of 8.32-9.36%. B8330 is a Class IIIB combustible liquid with a flash point of 207° F. (97.22° C.). B8330 has a density of 0.98-1.02 g/cc at 77° F. (25° C.), as measured by the DIN 51757 method. B8330 is water soluble at 25° C., has a pH of 4-7 at 40 g/l water at 25° C. and a dynamic viscosity of 100-300 mPa·s at 25° C. as measured by the DIN 53015 (Höppler) method.

According to a product sheet for the material (Publication No. 140-11-078-GLB dated 2012) (incorporated herein in its entirety by reference), the B-16 catalyst, which is marked under the name Dabco B-16 Catalyst, is an amine catalyst. B-16 is a light yellow liquid with a specific gravity of 0.80 g/cc at 25° C., a viscosity of 9 mPa·s at 25° C., and a flash point at 39.5° C.

According to its material safety data sheet, dated Nov. 9, 2009 (incorporated herein in its entirety by reference), M-75 is a polyurethane catalyst in liquid form that is sold under the name Jeffcat M 75 (referred herein as “M-75”). M-75 include three components: (1) N-butyl morpholine at a concentration of 60-100%, (2) diethylene glycol monobutyl ether at a concentration of 13-30%, and (3) N,N′-dimethylpiperazine at a concentration of 3-10%. M-75 has a flash point of 125.6° F. (52° C.) (closed cup). M-75 has a specific gravity of 0.9 and a kinematic viscosity of <0.2 cm²/s (<20 cSt at 40° C.).

According to a product sheet for the material (incorporated herein in its entirety by reference), T-80 is a material sold under the trademark Desmodur T 80 (referred to herein as “T-80”) by the Bayer corporation. T-80 is a mixture of two isomeric forms of 2,4-toluene diisocyanate and 2,6-toluene diisocyanate in the ratio of 80:20. According to its product sheet, the 2,4-isomer content is between 79.5-81.5% by weight. Hydroysable chlorine content is ≦0.01% by weight. Acidity is ≦0.004% by weight. T-80 is a colorless to pale liquid with a density of 1.22 g/cc at 25° C. (DIN 51757) and a density of about 3 mPa·s at 25° C. (DIN 53015). The flash point of T-80 is 127° C. (DIN 51758).

According to a product sheet for the material dated May 10, 2011 (incorporated herein in its entirety by reference), T-65 is a material sold under the trademark Desmodur T 65 N (referred to herein as “T-65”) by the Bayer corporation. T-65 is a mixture of two isomeric forms of 2,4-toluene diisocyanate and 2,6-toluene diisocyanate. According to its product sheet, the 2,4-isomer content is between 66-68% by weight. Hydroysable chlorine content is ≦100 mg/kg. Acidity is ≦40 mg/kg. T-65 is a colorless to pale liquid with a density of 1.22 g/cc at 25° C. (DIN 51757) and a density of about 3 mPa·s at 25° C. (DIN 53015). The flash point of T-65 is 127° C. (DIN 51758). Toluene diisocyanate formulations are available from under other brand names and are considered suitable for the present invention.

The T-65 material alternatively may be a material sold under the trademark Mondur TD-65 by the Bayer Corporation. According to the manufacturer's material data safety sheet dated Sep. 19, 2013 (incorporated herein in its entirety by reference), this variant of T-65 includes 60-100% by weight of 2,4-toluene diisocyanate and 30-40% by weight of 2,6-toluene diisocyanate. This variant of T-65 is a colorless to light yellow liquid with a freezing point of 10° C. (50° F.), a boiling point of 251.67-253.89° C. (485.01-489° F.) @ 1,013 hPa, a flash point of 128° C. (262.4° F.) (DIN 51758), a density of 1.22 g/cm³ @ 20° C. (68° F.) (DIN 51757), and a specific gravity of 1.22 @ 20° C. (68° F.).

As indicated in Table #1, and as a supplement to the discussion provided above, in several contemplated embodiments, the foam of the present invention may have a density of about 1.8 pcf (pounds per cubic foot or lb/ft³) (0.0288 g/cc or g/cm³). In addition, it is contemplated that the foam may have a density that is within ±10% of this density. In other words, embodiments of the foam of the present invention contemplate a foam density of between about 1.6-2.0 pcf (0.0256-0.320 g/cc). Separately, it is contemplated that the foam may have a density that is within ±5% of 1.8 pcf (0.0288 g/cc). In such instances, it is contemplated that the foam will have a density between about 1.7-1.9 pcf (0.0272-0.0304 g/cc). Still further, it is contemplated that the density of the foam of the present invention may deviate from about 1.8 pcf (0.0288 g/cc) by ±2%. If so, it is contemplated that the density may vary between about 1.76-1.84 pcf (0.0282-0.0295 g/cc).

As also indicated in Table #1, the foam of the present invention is contemplated to have a pore size of about 40 ppi. While a wider range of pore sizes is discussed above, in connection with the variants listed in Table #1, it is contemplated that the pore size may be within about ±10% from this or between about 35-45 ppi. Separately, the foam of the present invention may vary between about ±5% from 40 ppi. As such, it is contemplated that the foam of the present invention may exhibit a pore density of about 38-42 ppi. Still further, it is contemplated that the pore density may vary between about 39-41 ppi without departing from the scope of the present invention.

Concerning the individual compounds listed in Table #1, it is contemplated that the proportions of these compounds may be varied from the amounts listed without departing from the scope of the present invention. In particular, it is contemplated that the proportions of each of the compounds may be varied with ranges of about ±10%, ±5%, ±2%, or ±1% from the tabulated proportions.

With these variations in mind, therefore the proportions of 2C-76 may be varied from about 90-110 parts by weight, 95-105 parts by weight, 98-102 parts by weight, or 99-101 parts by weight without departing from the scope of the present invention. Similarly, B8330 may be varied from about 0.9-1.1 parts by weight, 0.95-1.05 parts by weight, 0.98-1.02 parts by weight, or 0.99-1.01 parts by weight while remaining within the scope of the present invention. Also, the proportions of M-75 may be varied between about 1.89-2.31 parts by weight, 2.00 -2.21 parts by weight, 2.06-2.14 parts by weight, or 2.08-2.12 parts by weight without departing from the scope of the present invention. Next, it is contemplated that the proportions of B-16 may be varied within the ranges of about 0.126-0.154, 0.133-0.147, 0.137-0.143, or 0.139-0.141 parts by weight without departing from the scope of the present invention. The proportion of water in the mixture may be varied within ranges of about 3.348-4.092, 3.534-3.906, 3.646-3.794, or 3.683-3.757 part by weight without departing from the scope of the present invention. Finally, with continued reference to Table #1, the proportions of T-80 and T-65 may be varied between about 23.49-28.71, 24.80-27.41, 25.58-26.62, or 25.84-26.36 parts by weight without departing from the scope of the present invention.

To manufacture the hydrophilic polyurethane foam of the present invention, the ingredients listed in Examples ##1-3 are mixed in the proportions identified or within the ranges of the proportions identified. The foam created by the ingredients is then reticulated thermally (or via some alternative reticulation process) to form an open cell structure.

To create a ceramic filter structure, the reticulated foam is wetted with a ceramic slurry within the time periods identified above. Once wetted with the ceramic slurry, the foam is subject to firing (i.e., in a kiln) until the ceramic slurry transitions to a solid ceramic structure and the foam burns away. As should be apparent to those skilled in the art, the temperature and duration of the firing depends upon a number of variables including, but not limited to, the thickness of the foam impregnated with the ceramic slurry. After firing, the ceramic filter possess the reticulated structure of the polyurethane foam and may be used in the manner intended to filter molten metals or other suitable liquids.

As should be apparent to those skilled in the art, the present invention is not intended to be limited to the materials and the specifications provided above. To the contrary, after appreciating the discussion of the present invention, those skilled in the art should appreciate that there are numerous variations and equivalents thereto. The present invention is contemplated to encompass those variations and equivalents.

What is claimed is:

1. A hydrophilic, polyurethane foam, formed from a composition comprising:
90-110 parts by weight of polyester polyol;
0.9-1.1 parts by weight of ester surfactant;
3-20 parts by weight of a hydrophilic surfactant;
1.89-2.31 parts by weight of a polyurethane catalyst;
0.126-0.154 parts by weight of an amine catalyst;
3.348-4.092 parts by weight of water; and
46.98-57.42 parts by weight of toluene diisocyanate,
wherein the polyurethane is capable of absorbing water in a time period of about 5 minutes or less, and
wherein the foam is a precursor to the formation of a molten metal filter.

2. The foam of claim 1, comprising 3-15 parts by weight of a hydrophilic surfactant.

3. The foam of claim 2, comprising 3-10 parts by weight of a hydrophilic surfactant.

4. The foam of claim 3, comprising 4-9 parts by weight of a hydrophilic surfactant.

5. The foam of claim 4, comprising 5-8 parts by weight of a hydrophilic surfactant.

6. The foam of claim 5, comprising 6-7 parts by weight of a hydrophilic surfactant.

7. The foam of claim 1, wherein the foam is reticulated.

8. The foam of claim 7, wherein the foam is thermally reticulated.

9. The foam of claim 1, wherein the toluene diisocyanate includes at least two isomeric forms comprising 2,4-toluene diiscynate and 2,6-toluene diisocyanate.

10. The foam of claim 1, comprising:
95-105 parts by weight of polyester polyol;
0.95-1.05 parts by weight of ester surfactant;
2.00-2.21 parts by weight of a polyurethane catalyst;
0.33-0.147 parts by weight of an amine catalyst;
3.534-3.906 parts by weight of water; and
49.60-54.82 parts by weight of toluene diisocyanate.

11. The foam of claim 10, comprising:
98-102 parts by weight of polyester polyol;
0.98-1.02 parts by weight of ester surfactant;
2.06-2.14 parts by weight of a polyurethane catalyst;
0.137-0.143 parts by weight of an amine catalyst;
3.646-3.794 parts by weight of water; and
51.16-53.24 parts by weight of toluene diisocyanate.

12. The foam of claim 11, comprising:
99-101 parts by weight of polyester polyol;
0.99-1.01 parts by weight of ester surfactant;
2.08-2.12 parts by weight of a polyurethane catalyst;
0.139-0.141 parts by weight of an amine catalyst;
3.683-3.757 parts by weight of water; and
51.68-52.72 parts by weight of toluene diisocyanate.

13. The foam of claim 1, wherein the hydrophilic surfactant comprises polyether modified polysiloxane.

14. The foam of claim 13, wherein the hydrophilic surfactant comprises:
poly(oxy-1,2-ethanediyl), a-methyl-w-[3-[1,3,3,3-tetramethyl-1-[(trimethylsilyl)oxy]disiloxanyl]propoxy]; and
disiloxane, hexamethyl.

15. The foam of claim 1, wherein the foam forms a web including pores with a density of about 2-100 ppi.

16. The foam of claim 15, wherein the density is about 2-70 ppi.

17. The foam of claim 16, wherein the density is about 5-35 ppi.

18. The foam of claim 17, wherein the density is about 10-30 ppi.

19. The foam of claim 1, wherein the time period is less than about four (4) minutes.

20. The foam of claim 19, wherein the time period is less than about three (3) minutes.

21. The foam of claim 20, wherein the time period is less than about two (2) minutes.

22. The foam of claim 21, wherein the time period is less than about one (1) minute.

23. The foam of claim 1, wherein the foam has a density of between about 1.2 and 3 lb/ft³ (0.019-0.048 g/cm³).

24. The foam of claim 23, wherein the foam has a density of between about 1.4 and 1.9 lb/ft³ (0.022-0.030 g/cm³).
